(19) United States
(12) Patent Application Publication
(10) Pub. No.: US 2011/0122228 A1
(43) Pub. Date: May 26, 2011

(54) THREE-DIMENSIONAL VISUAL SENSOR

(75) Inventors: Shiro Fujieda, Otokuni-gun (JP); Atsushi Taneno, Kusatsu-shi (JP); Reiji Takahashi, Kyoto-shi (JP); Masanao Yoshino, Nagaokakyo-shi (JP); Kenichi Ukai, Kusatsu-shi (JP)

(73) Assignee: OMRON CORPORATION

(21) Appl. No.: 12/943,565

(22) Filed: Nov. 10, 2010

(30) Foreign Application Priority Data
Nov. 24, 2009 (JP) 2009-266776

(51) Int. Cl. H04N 13/02

(52) U.S. Cl. 348/46; 348/E13.074

(57) ABSTRACT

A perspective transformation is performed to a three-dimensional model and a model coordinate system indicating a reference attitude of the three-dimensional model to produce a projection image expressing a relationship between the model and the model coordinate system, and a work screen is started up. A coordinate of an origin in the projection image and rotation angles of an X-axis, a Y-axis, and a Z-axis are displayed in work areas on the screen to accept a manipulation to change the coordinate and the rotation angles. The display of the projection image is changed by a manipulation. When an OK button located is pressed, the coordinate and rotation angle are fixed, and the model coordinate system is changed based on the coordinate and rotation angle. A coordinate of each constituent point of the three-dimensional model is transformed into a coordinate of the post-change model coordinate system.

### CROSS-REFERENCE TO RELATED PATENT APPLICATIONS

Japan Priority Application 2009-266776, filed Nov. 24, 2009 including the specification, drawings, claims and abstract, is incorporated herein by reference in its entirety.

### BACKGROUND OF THE INVENTION

1. Technical Field

The present invention relates to a three-dimensional visual sensor that obtains a plurality of three-dimensional coordinates expressing a recognition target by stereo measurement, recognizes a position and an attitude of the recognition target by matching the three-dimensional coordinates with a previously registered three-dimensional model of the recognition target, and outputs the recognition result.

2. Related Art

In a picking system of a factory, the position and attitude of a workpiece to be grasped by a robot are recognized by the stereo measurement, and an arm operation of the robot is controlled based on the recognition result. In order to realize the control, a three-dimensional coordinate system of a stereo camera is previously specified in a measurement target space by calibration, and a three-dimensional model expressing a three-dimensional shape of a model of the workpiece is produced using a full-size model or CAD data of the workpiece. Generally, the three-dimensional model is expressed as a set of three-dimensional coordinates of a three-dimensional coordinate system (hereinafter, referred to as “model coordinate system”) in which one point in the model is set to an origin, and a reference attitude of the workpiece is expressed by a direction in which each coordinate axis is set with respect to the set of three-dimensional coordinates.

In three-dimensional recognition processing, the three-dimensional coordinates of a plurality of feature points extracted from a stereo image of the recognition target are computed based on a previously specified measurement parameter, and the three-dimensional model is matched with a distribution of the feature points while the position and attitude are changed. When a degree of coincidence between the three-dimensional model and the distribution becomes the maximum, a coordinate corresponding to an origin of the model coordinate system is recognized as the position of the recognition target. When the degree of coincidence becomes the maximum, a rotation angle with respect to each corresponding coordinate axis of a measurement coordinate system is computed in a direction corresponding to each coordinate axis of the model coordinate system, and the rotation angle is recognized as the attitude of the recognition target.

In order to control the robot operation based on the recognition result, it is necessary to transform the coordinate and the rotation angle, which indicate the recognition result, into a coordinate and a rotation angle of a world coordinate system that is set based on the robot (for example, see Japanese Unexamined Patent Publication No. 2007-171018).

In order that the robot grasps the workpiece more stably in the picking system, it is necessary to provide a coordinate expressing a target position in a leading end portion of an arm or an angle indicating a direction of the arm extended toward the target position to the robot. The coordinate and the angle are determined by an on-site person in charge on the condition that the workpiece can be grasped stably. However, the position and the attitude, recognized by the three-dimensional model, are often unsuitable for the condition. Particularly, when the three-dimensional model is produced using the CAD data, because a definition of the coordinate system determined in the CAD data is directly reflected on the model coordinate system, there is a high possibility of setting the model coordinate system unsuitable for robot control.

Recently, the applicant has developed a general-purpose visual sensor to find the following fact. When the recognition processing unsuitable for the robot control is performed in introducing this kind of visual sensor to a picking system, it is necessary in a robot controller to transform the coordinate and rotation angle, inputted from a three-dimensional visual sensor, into the coordinate and angle, suitable for the robot control. As a result, a load on computation of the robot controller is increased to take a long time for the robot control, which results in a problem in that a picking speed is hardly enhanced.

### SUMMARY

The present invention alleviates the problems described above, and an object thereof is to change the model coordinate system of the three-dimensional model such that the coordinate and rotation angle, outputted from the three-dimensional visual sensor, become suitable to the robot control by a simple setting manipulation.

In accordance with one aspect of the present invention, there is provided a three-dimensional visual sensor applied with the present invention including: a registration unit in which a three-dimensional model is registered, a plurality of points indicating a three-dimensional shape of a model of a recognition target being expressed by a three-dimensional coordinate of a model coordinate system in the three-dimensional model, one point in the model being set to an origin in the model coordinate system; a stereo camera that images the recognition target; a three-dimensional measurement unit that obtains a three-dimensional coordinate in a previously determined three-dimensional coordinate system for measurement with respect to a plurality of feature points expressing the recognition target using a stereo image produced with the stereo camera; a recognition unit that matches a set of three-dimensional coordinates obtained by the three-dimensional measurement unit with the three-dimensional model to recognize a three-dimensional coordinate corresponding to the origin of the model coordinate system and a rotation angle of the recognition target with respect to a reference attitude of the three-dimensional model indicated by the model coordinate system; an output unit that outputs the three-dimensional coordinate and rotation angle, which are recognized by the recognition unit; an acceptance unit that accepts a manipulation input to change a position or an attitude in the three-dimensional model of the model coordinate system; and a model correcting unit that changes each of the three-dimensional coordinates constituting the three-dimensional model to a coordinate of the model coordinate system changed by the manipulation input and registers a post-change three-dimensional model in the registration unit as the three-dimensional model used in the matching processing of the recognition unit.

The three-dimensional visual sensor according to the present invention also includes an acceptance unit that accepts a manipulation input to change a position or an attitude in the three-dimensional model of the model coordinate system; and a model correcting unit that changes each three-dimensional coordinate constituting the three-dimensional model to a coordinate of the model coordinate system changed by the manipulation input and registers a post-change three-dimensional model in the registration unit as the three-dimensional model used in the matching processing of the recognition unit.

With the above configuration, based on the user manipulation input, the model coordinate system and the three-dimensional coordinates constituting the three-dimensional model are changed and registered as the three-dimensional model for the recognition processing, so that the coordinate and rotation angle, outputted from the three-dimensional visual sensor, can be fitted to the robot control.

The manipulation input is not limited to one time, but the manipulation input can be performed as many times as needed until the post-change model coordinate system becomes suitable for the robot control. Therefore, for example, the user can change the origin of the model coordinate system to a target position in a leading end portion of the robot arm, and the user can change each coordinate axis direction such that the optimum attitude of the workpiece with respect to the robot becomes the reference attitude.

According to a preferred aspect, the three-dimensional visual sensor further includes: a perspective transformation unit that disposes the three-dimensional model while determining the position and the attitude of the model coordinate system with respect to the three-dimensional coordinate system for measurement and produces a two-dimensional projection image by performing perspective transformation to the three-dimensional model and the model coordinate system from a predetermined direction; a display unit that displays a projection image produced through the perspective transformation processing on a monitor; and a display changing unit that changes display of the projection image of the model coordinate system in response to the manipulation input.

According to the above aspect, the user can confirm whether the position of the origin of the model coordinate system and the direction of each coordinate axis are suitable for the robot control by the projection image displays of the three-dimensional model and model coordinate system. When one of the three-dimensional model and the model coordinate system is unsuitable for the robot control, the user performs manipulation input to change the unsuitable point.

According to a further preferred aspect of the three-dimensional visual sensor, the display unit displays a three-dimensional coordinate of a point corresponding to the origin in the model coordinate system before the model coordinate system is changed by the model correcting unit on the monitor on which the projection image is displayed as the three-dimensional coordinate of the point corresponding to the origin of the model coordinate system in the projection image, and the display unit displays a rotation angle, formed by a direction corresponding to each coordinate axis of the model coordinate system in the projection image and each coordinate axis of the model coordinate system before the model coordinate system is changed by the model correcting unit, on the monitor on which the projection image is displayed as an attitude indicated by the model coordinate system in the projection image. The acceptance unit accepts a manipulation to change the three-dimensional coordinate or the rotation angle, which are displayed on the monitor.

According to the above aspect, the position of the origin and the direction indicated by each coordinate axis in the projection image are displayed by the specific numerical values using the model coordinate system at the current stage to encourage the user to change the numerical values, so that the model coordinate system and each coordinate of the three-dimensional model can easily be changed.

According to the present invention, the model coordinate system can easily be corrected to one suitable for the robot control while the setting of the model coordinate system to the three-dimensional model is confirmed. Therefore, the coordinate and angle, outputted from the three-dimensional visual sensor, become suitable for the robot control to be able to enhance the speed of the robot control.

### BRIEF DESCRIPTION OF THE DRAWINGS

FIG. 1 is a view showing a configuration of a picking system to which a three-dimensional visual sensor is introduced;

FIG. 2 is a block diagram showing an electric configuration of the three-dimensional visual sensor;

FIG. 3 is a view schematically showing a configuration of a three-dimensional model used to recognize a workpiece;

FIG. 4 is a view showing an example of a work screen used to correct a model coordinate system;

FIG. 5 is a view showing an example of the work screen in performing a manipulation to change a coordinate axis direction of the model coordinate system;

FIG. 6 is a view showing an example of the work screen in performing a manipulation to change a position of an origin of the model coordinate system; and

FIG. 7 is a flowchart showing a procedure of processing of correcting the three-dimensional model.

### DETAILED DESCRIPTION

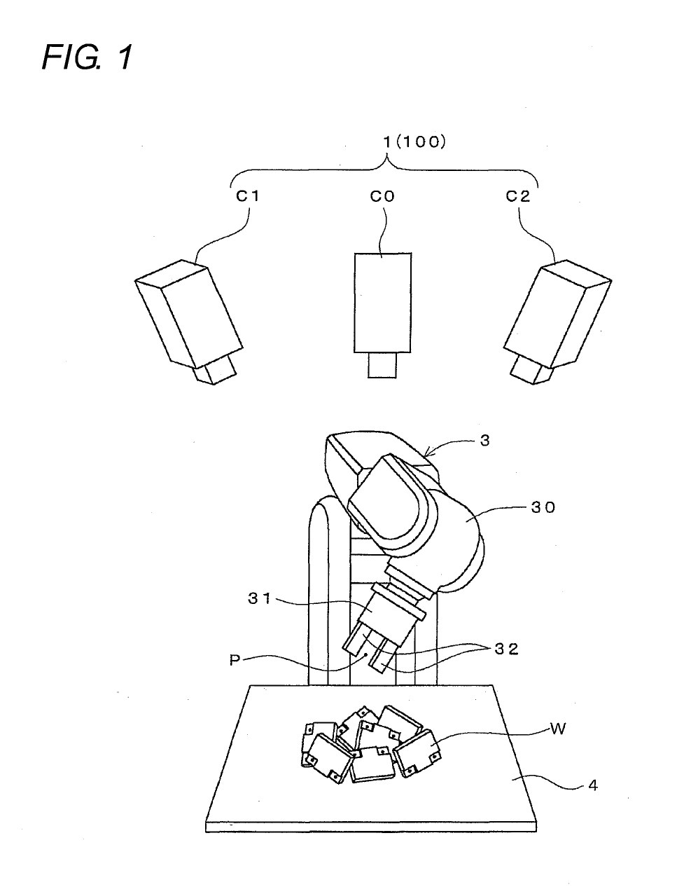

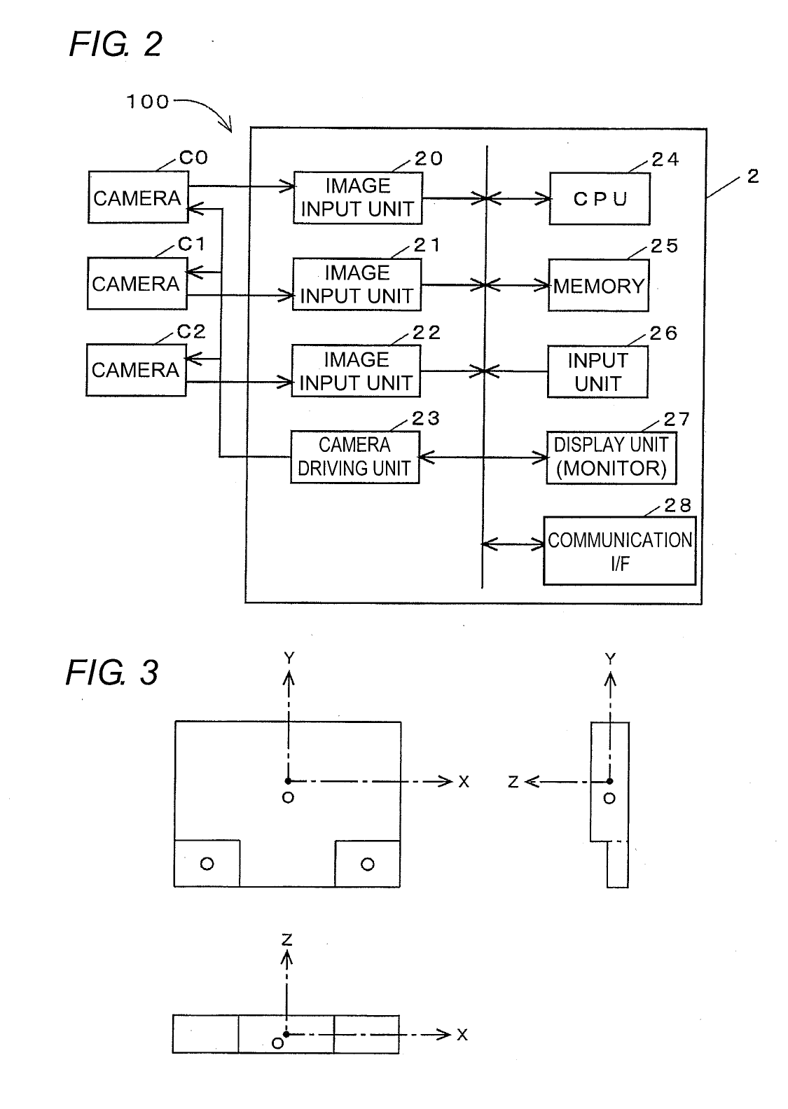

FIG. 1 shows a picking system to which a three-dimensional visual sensor is introduced, and FIG. 2 shows a configuration of the three-dimensional visual sensor.

The picking system of this embodiment is used to pick up one by one a workpiece W disrupted on a tray 4 to move the workpiece W to another location. The picking system includes a three-dimensional visual sensor 100 that recognizes the workpiece W, a multijoint robot 3 that performs actual work, and a robot controller (not shown).

The three-dimensional visual sensor 100 includes a stereo camera 1 and a recognition processing device 2.

The stereo camera 1 includes three cameras C0, C1, and C2. The central camera C0 is disposed while an optical axis of the camera C0 is oriented toward a vertical direction (that is, the camera C0 takes a front view image), and the right and left cameras C1 and C2 are disposed while optical axes of the cameras C1 and C2 are inclined.

The recognition processing device 2 is a personal computer in which a dedicated program is stored. In the recognition processing device 2, images produced by the cameras C0, C1, and C2 are captured to perform three-dimensional measurement aimed at an outline of the workpiece W, and the three-dimensional information restored by the three-dimensional measurement is matched with a previously registered three-dimensional model, thereby recognizing a position and an attitude of the workpiece W. Then, the recognition processing device 2 outputs a three-dimensional coordinate expressing the recognized position of the workpiece W and a rotation angle (expressed in each of axes X, Y, and Z) of the workpiece W with respect to the three-dimensional model to the robot controller. Based on the pieces of information, the robot controller controls operations of an arm 30 and a hand portion 31 of the robot 3, disposes claw portions 32 and 32 of a leading end in an attitude suitable for the grasp of the workpiece W at a position suitable for the grasp of the workpiece W, and causes the claw portions 32 and 32 to grasp the workpiece W.

Referring to FIG. 2, the recognition processing device 2 includes image input units 20, 21, and 22 corresponding to the cameras C0, C1, and C2, a camera driving unit 23, a CPU 24, a memory 25, an input unit 26, a display unit 27, and a communication interface 28.

The camera driving unit 23 simultaneously drives the cameras C0, C1, and C2 in response to a command from the CPU 24. The images produced by the cameras C0, C1, and C2 are inputted to the memory 25 through the image input units 20, 21, and 22, respectively, and the CPU 24 performs the above-mentioned recognition processing.

The display unit 27 is a monitor device such as a liquid crystal display. The input unit 26 includes a keyboard and a mouse. In calibration processing or in three-dimensional model registration processing, the input unit 26 and the display unit 27 are used to input the information for setting and to display the information for assisting the work.

The communication interface 28 is used to conduct communication with the robot controller.

The memory 25 includes a ROM, a RAM, and a large-capacity memory such as a hard disk. A program for the calibration processing, a program for producing the three-dimensional model, a program for the three-dimensional recognition processing of the workpiece W, and setting data are stored in the memory 25. Three-dimensional measurement parameters computed through the calibration processing and the three-dimensional model are also registered in a dedicated area of the memory 25.

Based on a program in the memory 25, the CPU 24 performs pieces of processing of producing and registering the three-dimensional model of the workpiece W after computing and registering the three-dimensional measurement parameter. By performing the two kinds of setting processing, the three-dimensional measurement and the recognition processing can be performed to the workpiece W.

A function of producing a three-dimensional model indicating an outline of the workpiece W by utilizing CAD data of the workpiece W and a function of correcting a data structure of the three-dimensional model into contents suitable for control of the robot are provided in the recognition processing device 2 of this embodiment. The function of correcting the three-dimensional model will be described in detail below.

FIG. 3 schematically shows a state in which the three-dimensional model of the workpiece W is observed from directions orthogonal to an XY-plane, a YZ-plane, and an XZ-plane.

In this three-dimensional model, a coordinate of each constituent point of the outline is expressed by a model coordinate system in which one point O indicated by the CAD data is set to an origin. Specifically, the workpiece W of this embodiment has a low profile, and the origin O is set to a central position of a thickness portion. An X-axis is set to a longitudinal direction of a surface having the largest area, a Y-axis is set to a transverse direction, and a Z-axis is set to a direction normal to the XY-plane.

The model coordinate system is set based on the CAD data of original data. However, the model coordinate system is not always suitable to cause the robot 3 of this embodiment to grasp the workpiece W. Therefore, in this embodiment, a work screen is displayed on the display unit 27 in order to change the setting of the model coordinate system, and the position of the origin O and the direction of each coordinate axis are changed in response to a setting changing manipulation performed by a user.

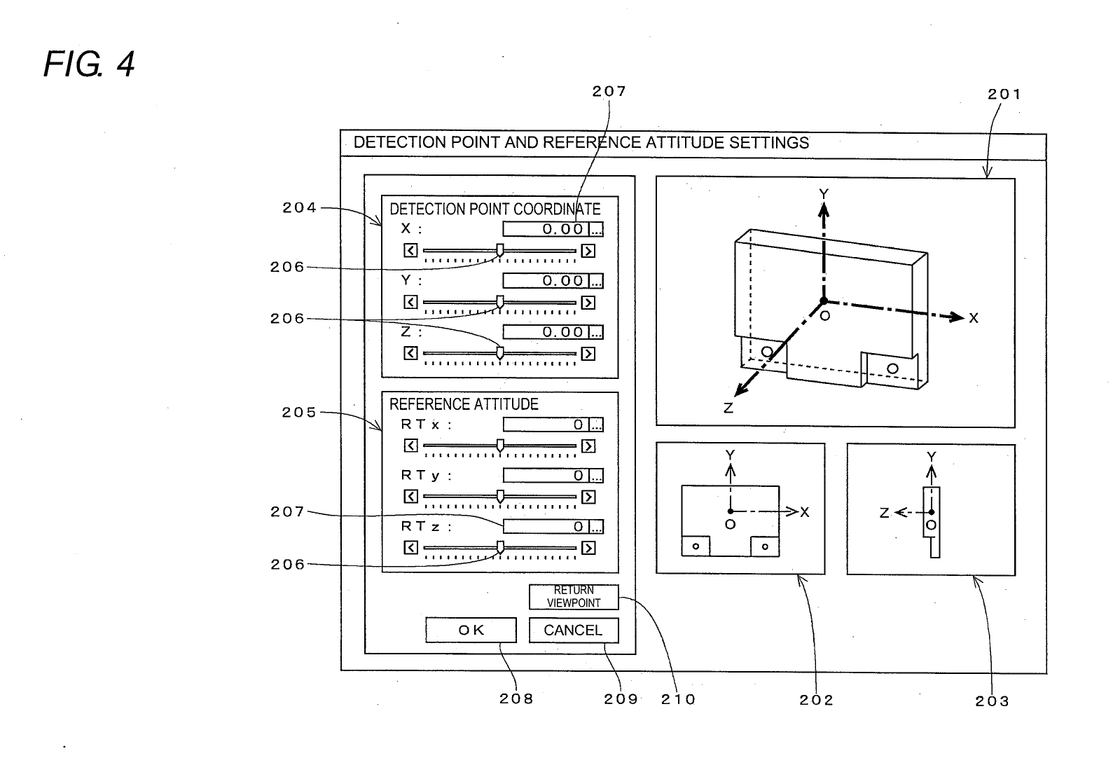

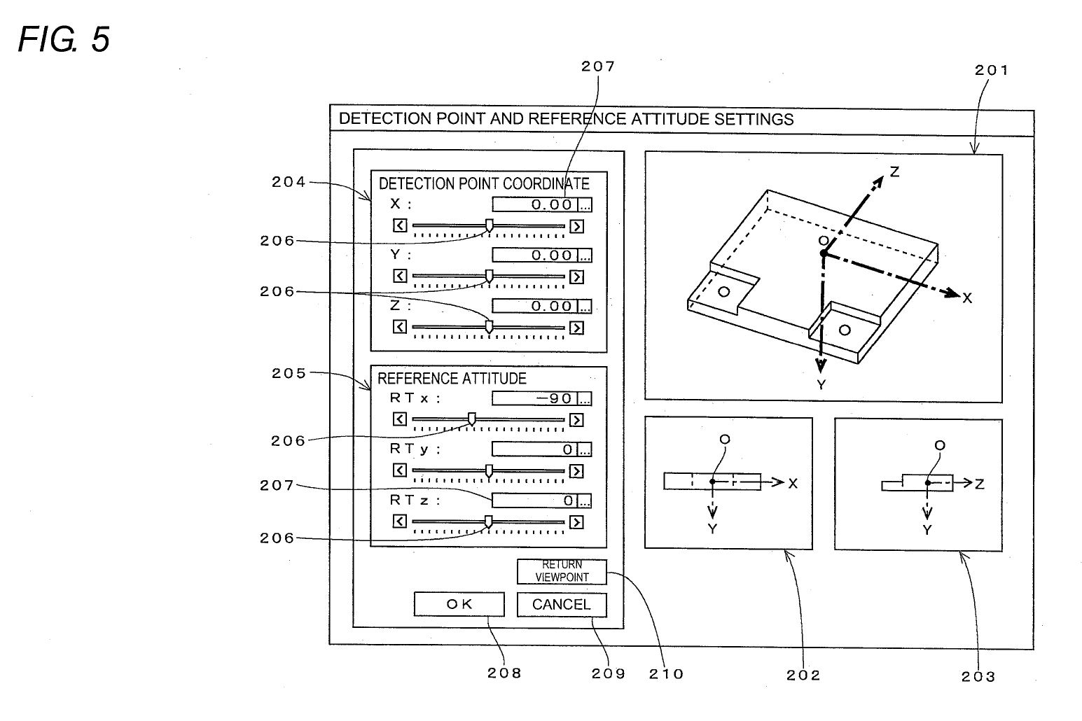

FIGS. 4 to 6 show examples of the work screen used to change the setting of the model coordinate system.

Three image display areas 201, 202, and 203 are provided on the right of the work screen, and projection images of the three-dimensional model and model coordinate system are displayed in the image display areas 201, 202, and 203. In the image display area 201 having the largest area, a sight line direction changing manipulation by the mouse is accepted to change the attitude of the projection image in various ways.

An image of a perspective transformation performed from a direction facing the Z-axis direction and an image of a perspective transformation performed from a direction facing the X-axis direction are displayed in the image display areas 202 and 203 that are arrayed below the image display area 201. Because the directions of the perspective transformation are fixed in the image display areas 202 and 203 (however, the directions can be selected by the user), the attitudes of the projection images are varied in the image display areas 202 and 203 when the coordinate axis of the model coordinate system is changed.

Two work areas 204 and 205 are vertically arrayed on the left of the screen in order to change the setting parameter of the model coordinate system. In the work area 204, the origin O of the model coordinate system is expressed as “detection point”, and a setting value changing slider 206 and a numerical display box 207 are provided in each of an X-coordinate, a Y-coordinate, and a Z-coordinate of the detection point.

In a work area 205, X-axis, Y-axis, and Z-axis directions of the model coordinate system indicating a reference attitude of the three-dimensional model are displayed by rotation angles RTx, RTy, and RTz. The setting value changing slider 206 and the numerical display box 207 are also provided in each of the rotation angles RTx, RTy, and RTz.

Additionally an OK button 208, a cancel button 209, and a sight line changing button 210 are provided in the work screen of this embodiment. The OK button 208 is used to fix the coordinate of the origin O and setting values of the rotation angles RTx, RTy, and RTz. The cancel button 209 is used to cancel the change of setting value of the model coordinate system. The sight line changing button 210 is used to provide an instruction to return the viewpoint of the perspective transformation to an initial state.

In this embodiment, the model coordinate system set based on the CAD data is effectively set before the OK button 208 is pressed. The positions of the sliders 206 of the work areas 204 and 205 and numerical values in the display boxes 207 are set based on the currently-effective model coordinate system.

Specifically, in the work area 204, the position of the origin O displayed in each of the image areas 201, 202, and 203 is expressed by the X-coordinate, Y-coordinate, and Z-coordinate of the current model coordinate system. Accordingly, the origin O is not changed when (0, 0, 0) is the coordinate (X, Y, Z) displayed in the work area 204.

In the work area 205, each of the X-axis, Y-axis, and Z-axis directions of the model coordinate system set based on the CAD data is set to 0 degrees, and the rotation angles in the directions indicated by the X-axis, Y-axis, and Z-axis in the projection image are set to RTx, RTy, and RTz with respect to the X-axis, Y-axis, and Z-axis directions. Accordingly, the axis direction of the model coordinate system is not changed when each of the RTx, RTy, and RTz are set to 0 degrees.

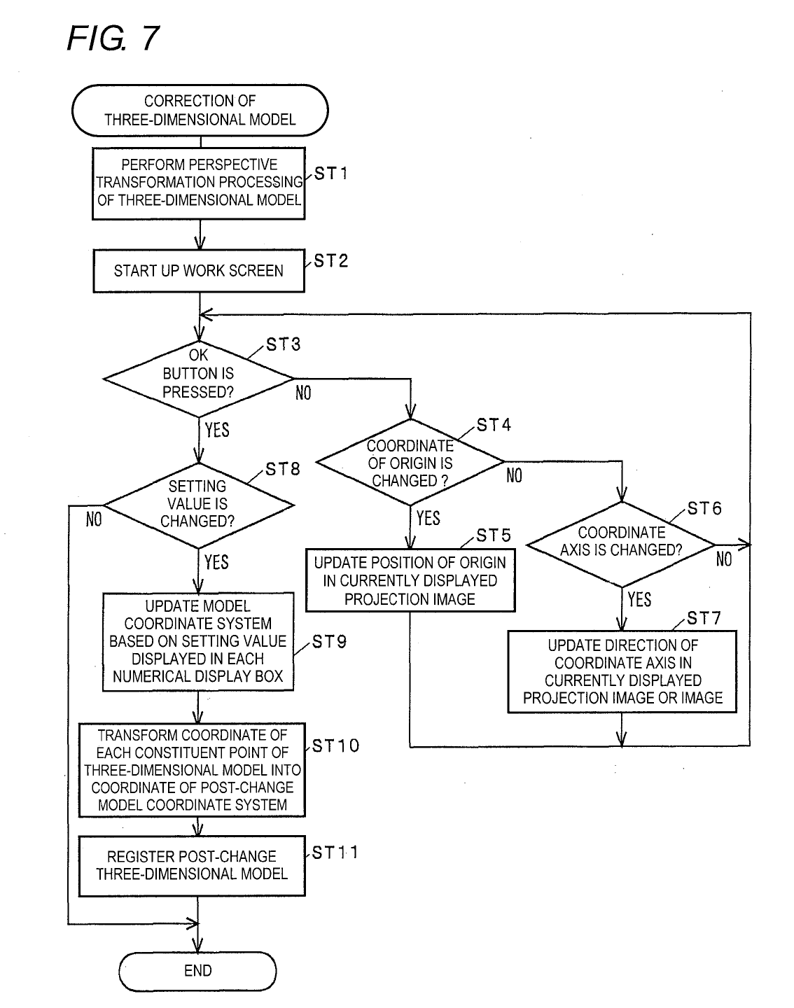

FIG. 7 shows a procedure of changing the setting of the model coordinate system by the work screen. Hereinafter, with reference to FIG. 7 and FIGS. 4 to 6, work to change the setting of the model coordinate system and processing performed by the CPU 24 according to the work will be described.

In this embodiment, it is assumed that one point P (shown in FIG. 1) in a space between the claw portions 32 and 32 is set to a reference point when the claw portions 32 and 32 of the robot 3 are opened, and it is assumed that the origin O is changed to a position of the reference point P located immediately before the grasp of the workpiece W. It is assumed that each axis direction is changed such that a length direction faces the positive direction of the Z-axis when the arm portion 30 is extended and such that a direction parallel to the claw portions 32 and 32 faces the Y-axis direction.

The processing shown in FIG. 7 is started according to the three-dimensional model produced using the CAD data. The CPU 24 virtually disposes the X-axis, Y-axis, and Z-axis of the model coordinate system to the three-dimensional coordinate system for measurement in a predetermined attitude to perform the perspective transformation processing from the three directions (ST1). The CPU 24 starts up the work screen including the projection image produced through the processing in ST1 (ST2). FIG. 4 shows the screen immediately after the start-up. In FIG. 4, the model coordinate system that is set based on the CAD data is directly displayed in each of the image display areas 201, 202, and 203. The slider 206 and the numerical display box 207 are set to zero in each of the work areas 204 and 205.

On the screen shown in FIG. 4, the user freely changes the X-coordinate, Y-coordinate, and Z-coordinate of the origin O and the rotation angles RTx, RTy, and RTz of the coordinate axis by the manipulation of the slider 206 or the numerical value inputted to the numerical display box 207. The user can also change the projection image in the image display area 201 to the projection image from the different sight line direction as the need arises.

When the coordinate of the origin O is changed (“YES” in ST4), the CPU 24 computes the post-change origin O in the projection image of each of the image display areas 201, 202, and 203, and updates the display position of the origin O in each projection image according to the computation result (ST5). Therefore, the origin O is displayed at the position changed by the manipulation.

When the rotation angle of one of the X-coordinate axis, Y-coordinate axis, and Z-coordinate axis is changed, it is determined as “YES” in ST6 and the flow goes to ST7. In ST7, the CPU 24 performs the perspective transformation processing while the coordinate axis that becomes the angle changing target is rotated by the changed rotation angle, and updates the coordinate axis in the image display area 201 according to the result of the perspective transformation processing. The projection images in the image display areas 202 and 203 are updated such that the plane including the coordinate axis rotated by the rotation angle becomes the front view image. Through the pieces of processing, the state in which the corresponding coordinate axis is rotated according to the rotation angle changing manipulation can be displayed.

FIG. 5 shows an example of the screen that is changed according to the change of the rotation angle RTx about the X-axis after the screen of FIG. 4 is displayed. In the example of FIG. 5, the projection image in the image display area 201 is changed in response to the user manipulation, and the Y-axis and Z-axis directions are changed by the rotation of the model coordinate system according to the rotation angle RTx. The projection image in the image display area 201 is also changed to the projection image expressing the result of the performance of the perspective transformation processing from the direction orthogonal to the post-change YX-plane and YZ-plane.

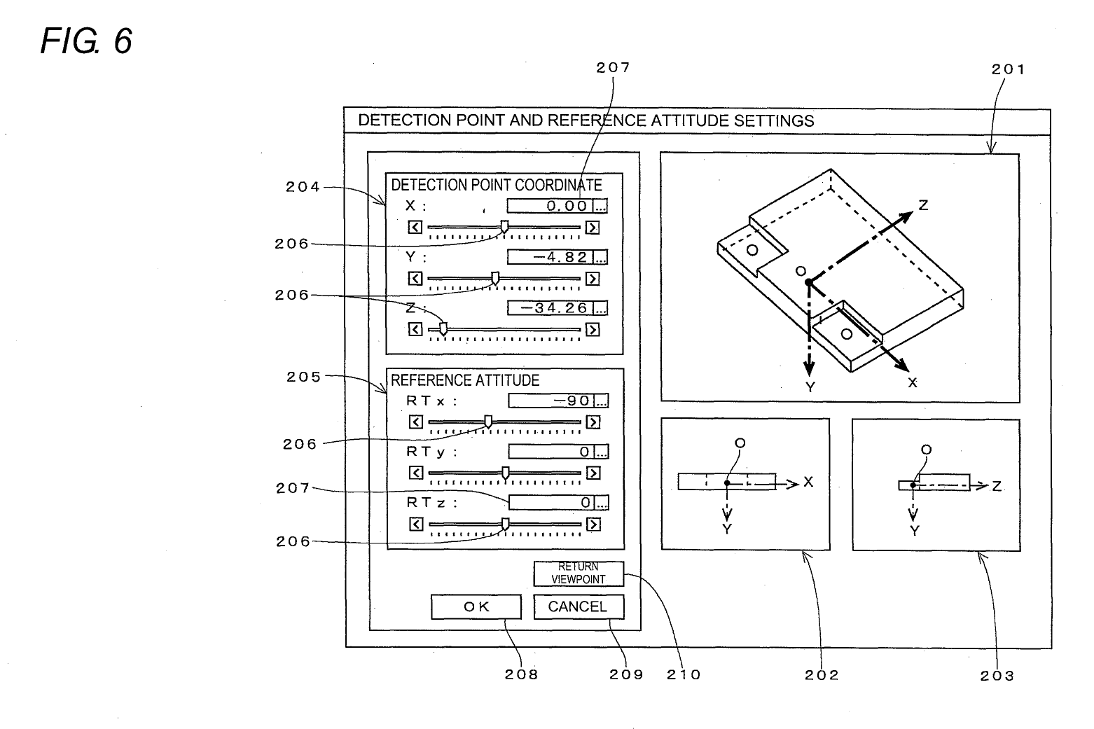

FIG. 6 shows an example of the screen in which the position of the origin O is further changed after the screen of FIG. 5 is displayed. In this embodiment, the origins O in the image display areas 201 and 202 and the display position of each coordinate axis are changed in association with the changes of the Y-coordinate and Z-coordinate.

Referring to FIG. 7, the description will be continued. The user changes the model coordinate system on the work screen such that the model coordinate system becomes suitable for the control of the robot 3 by the above method, and the user presses the OK button 208, whereby it is determined as “YES” in ST3 and ST8. In response to the determination of “YES”, the CPU 24 fixes the setting value displayed in the input box 207 of each of the work areas 204 and 205 at that stage, and the origin O and the X-axis, Y-axis, and Z-axis directions are changed based on the setting values (ST9). The CPU 24 changes the coordinate of each outline constituent point of the three-dimensional model to the coordinate of the post-change model coordinate system (ST10). The post-coordinate-transformation three-dimensional model is registered in the memory 25 (ST11), and the processing is ended.

It is to be noted that the original three-dimensional model is deleted in association with the registration of the post-coordinate-transformation three-dimensional model. However, the present invention is not limited thereto, and the original three-dimensional model may be retained while inactivated.

When the OK button 208 is pressed on the initial-state work screen shown in FIG. 4, the pieces of processing in ST9, ST10, and ST11 are skipped to end the processing. Although not shown in FIG. 7, when the cancel button 209 is pressed in the middle of the work, the setting value in each input box 207 is canceled to return to the initial-state work screen.

According to the processing, the user can easily perform the changing work so as to satisfy the condition necessary to cause the robot 3 to grasp the workpiece W while confirming the position of the origin O of the model coordinate system or the direction of the coordinate axis. This changing manipulation is performed using the X-coordinate, Y-coordinate, and Z-coordinate of the current model coordinate system and the rotation angles RTx, RTy, and RTz with respect to the coordinate axes, so that contents of the change can easily be reflected on the projection image. When the manipulation is performed to fix the changed contents (manipulation of the OK button 208), the model coordinate system can rapidly be changed using the numerical values displayed in the work areas 204 and 205.

In the three-dimensional visual sensor 100 in which the post-change three-dimensional model is registered, there is outputted information in which the direction of the arm 30 of the robot 3 and the position in which the arm 30 is extended are uniquely specified with respect to the workpiece W, so that the robot controller can rapidly control the robot 3 using the information. When the transformation parameter used to transform the coordinate of the three-dimensional coordinate system for measurement into the coordinate of the world coordinate system is registered in the three-dimensional visual sensor 100, the robot controller need not transform the information inputted from the three-dimensional visual sensor 100, which allows the load on the computation to be further reduced in the robot controller.

In the image display area 201 on the work screen, the projection image can be displayed from various sight line directions. However, in the initial display, desirably the projection image is displayed with respect to an imaging surface of one of the cameras C0, C1, and C2 so as to be able to be compared to the image of the actual workpiece W. In performing the perspective transformation processing to the imaging surface of the camera, a full-size model of the workpiece W is imaged with the cameras C0, C1, and C2 to perform the recognition processing using the three-dimensional model, and based on the recognition result, the perspective transformation processing may be performed to the image in which the three-dimensional model is superimposed on the full-size model. Therefore, the user can easily determine the origin and coordinate axis direction of the model coordinate system by referring to the projection image of the full-size model.

All the outline constituent points set in the three-dimensional model are displayed in the examples of FIGS. 4 to 6. Alternatively, the outline constituent points may be displayed while restricted to the outline constituent points that can visually be recognized from the perspective transformation direction. In the above embodiment, the model coordinate system is corrected for the three-dimensional model that is produced using the CAD data. However, also for the three-dimensional model that is produced using the stereo measurement result of the full-size model of the workpiece W, the model coordinate system can be changed through the similar processing when the model coordinate system is unsuitable for the robot control.

In the above embodiment, the three-dimensional model is displayed along with the model coordinate system, and the setting of the model coordinate system is changed in response to the user manipulation. However, the change of the setting of the model coordinate system is not limited to this method. Two possible methods will be described below.

(1) Use of Computer Graphics

The simulation screen of the work space of the robot 3 is started up by computer graphics, the picking operation performed by the robot 3 is simulated, and to specify the best target position for grasping the workpiece W with the claw portions 32 and 32 and the best attitude of the workpiece W. The origin and coordinate axis of the model coordinate system are changed based on this specification result, and the coordinate of each constituent point of the three-dimensional model is transformed into the coordinate of the post-change model coordinate system.

(2) Use of Stereo Measurement

In the work space of the robot 3, the state in which the robot 3 grasps the workpiece W with the best positional relationship is set to perform the stereo measurement with the cameras C0, C1, and C2, and the direction of the arm portion 30 and the positions and arrangement directions of the claw portions 32 and 32 are measured. The three-dimensional measurement is performed to the workpiece W, and the measurement result is matched with the initial-state three-dimensional model to specify the coordinate corresponding to the origin O and the X-coordinate axis, Y-coordinate axis, and Z-coordinate axis directions. A distance from the point corresponding to the origin O and the reference point P obtained from the measurement positions of the claw portions 32 and 32, the Z-axis rotation angle with respect to the direction of the arm portion 30, and the Y-axis rotation angle with respect to the direction in which the claw portions 32 and 32 are arranged are derived, and based on these values, the coordinate of the origin O in the three-dimensional model and the Y-coordinate axis and Z-coordinate axis directions are changed. The direction orthogonal to the YZ-plane is set to the X-axis direction.

What is claimed is:

1. A three-dimensional visual sensor comprising:
a registration unit in which a three-dimensional model is registered, a plurality of points indicating a three-dimensional shape of a model of a recognition object being expressed by a three-dimensional coordinate of a model coordinate system in the three-dimensional model, one point in the model being set to an origin in the model coordinate system;
a stereo camera that images the recognition target;
a three-dimensional measurement unit that obtains a three-dimensional coordinate in a predetermined three-dimensional coordinate system for measurement with respect to a plurality of feature points expressing the recognition target using a stereo image produced with the stereo camera;
a recognition unit that checks a set of three-dimensional coordinates obtained by the three-dimensional measurement unit with the three-dimensional model to recognize a three-dimensional coordinate corresponding to the origin of the model coordinate system and a rotation angle of the recognition target with respect to a reference attitude of the three-dimensional model indicated by the model coordinate system;
an output unit that outputs the three-dimensional coordinate and the rotation angle recognized by the recognition unit;
an acceptance unit that accepts a manipulation input to change a position or an attitude in the three-dimensional model of the model coordinate system; and
a model correcting unit that changes each of the three-dimensional coordinates constituting the three-dimensional model to a coordinate of the model coordinate system changed by the manipulation input and registers a changed three-dimensional model in the registration unit as the three-dimensional model used in the recognition unit.

2. The three-dimensional visual sensor according to claim 1, further comprising:
a perspective transformation unit that disposes the three-dimensional model after determining the position and the attitude of the model coordinate system with respect to the three-dimensional coordinate system for measurement and produces a two-dimensional projection image by performing perspective transformation to the three-dimensional model and the model coordinate system from a predetermined direction;
a display unit that displays a projection image produced through the perspective transformation processing on a monitor; and
a display changing unit that changes display of the projection image of the model coordinate system in response to the manipulation input.

3. The three-dimensional visual sensor according to claim 2,
wherein the display unit displays a three-dimensional coordinate of a point corresponding to the origin in the model coordinate system before the model coordinate system is changed by the model correcting unit on the monitor on which the projection image is displayed as the three-dimensional coordinate of the point corresponding to the origin of the model coordinate system in the projection image, and the display unit displays a rotation angle formed by a direction corresponding to each coordinate axis of the model coordinate system in the projection image and each coordinate axis of the model coordinate system before the model coordinate system is changed by the model correcting unit on the monitor on which the projection image is displayed as an attitude indicated by the model coordinate system in the projection image, and
wherein the acceptance unit accepts a manipulation to change the three-dimensional coordinate or the rotation angle displayed on the monitor.
